(19) United States
(12) Patent Application Publication
(10) Pub. No.: US 2026/0210857 A1
(43) Pub. Date: Jul. 23, 2026

(54) Method for Determining the Intensity of the Luminescence of Markers Present in a Test Field

(71) Applicant: fzmb GmbH Forschungszentrum fur Medizintechik und Biotechnologie, Bad Langensalza (DE)

(72) Inventors: Stephan Henze, Bad Langensalza (DE); Nico Correns, Weimar (DE)

(73) Assignee: fzmb GmbH Forschungszentrum fur Medizintechik und Biotechnologie, Bad Langensalza (DE)

(21) Appl. No.: 19/420,879

(22) Filed: Dec. 16, 2025

(30) Foreign Application Priority Data
Jan. 20, 2025 (EP) 25152862.6

(51) Int. Cl. G01N 21/64

(52) U.S. Cl. CPC G01N 21/6428; G01N 21/6408; G01N 21/6456; G01N 2021/6439

(57) ABSTRACT

With the invention, the afterglow of a fluorophore can be visualized by observation with a rolling-shutter camera under pulsed illumination. Image sections captured during a dark phase contain only the light emitted by long-lived fluorophores. This enables the imaging acquisition of long-lived fluorescence using inexpensive, widely available CMOS cameras without moving parts and without image intensifiers and without synchronization of camera and pulsed illumination.

### CROSS-REFERENCE TO RELATED APPLICATION

This application claims priority to European Patent Application No. 25152862.6 filed Jan. 20, 2025, the disclosure of which is hereby incorporated by reference in its entirety.

### BACKGORUND OF THE INVENTION

### Field of the Invention

The invention relates to a method for determining the intensity of the luminescence of markers present in a test field, e.g. of an immunoassay, e.g. of a lateral flow assay (see e.g. US 2015/111201 A1), with a known time constant representative of the time course of the luminescence, wherein the test field is reflective for excitation light at least in a partial region.

### Description of Related Art

Determining the intensity of the luminescence of markers is a requirement in many different ways in medicine, medical technology, biology and diagnostics, wherein fluorescence intensities are often of interest in these fields. Therefore, reference is made below to the physical phenomena of fluorescence as an introduction to the topic of luminescence and luminescence lifetime.

When creating fluorescence images, fluorescence and excitation light must be separated from each other. For optimum contrast, only the fluorescence light may contribute to the image, or fluorescence and excitation light must be imaged in different channels in a clearly distinguishable manner. This is normally done by pairwise blocking filters which together suppress the excitation light. These filters are expensive. They only achieve their full performance at certain angles of incidence, which means that large fields of view can only be captured with special lenses (part of the beam path with conjugate at infinity).

Alternatively, it is possible to differentiate between excitation and fluorescence light on the basis of the fluorescence lifetime.

The fluorescence lifetime indicates the average time that a molecule remains in an excited state before it emits a photon and thus returns to its ground state. The fluorescence lifetime is in the order of 10⁻⁹ s-10⁻⁷ s. The decay of the fluorescence follows an exponential law.

Typical fluorescence lifetimes are in the range of a few nanoseconds. It should be noted that this is a spin-permitted process (fluorescence). The spin-prohibited process (phosphorescence) results in orders of magnitude longer lifetimes in the range of milliseconds to hours.

The fluorescence lifetime is an important measurement parameter in spectroscopy and microscopy (fluorescence lifetime microscopy), which is used to differentiate between different fluorophores (including those of the same color). In addition, the fluorescence lifetime can provide important information about the chemical environment of a fluorophore and reveal energy transfer mechanisms such as Förster resonance energy transfer.

For example, the fluorescence lifetime in a cell is influenced by the immediate environment of the fluorophore, i.e. the fluorophores can serve as measuring probes of the environment.

The determination of fluorescence lifetimes requires the time-resolved recording of the intensity of emitted radiation. A common method for this is time-correlated single photon counting (TCSPC). In this respect, the sample is excited periodically with low-intensity monochromatic light flashes (laser, nanosecond flash lamp). The fluorescence is detected at a longer wavelength than the wavelength used for excitation (Monochromator on the emission side of the experimental set-up) with a secondary electron multiplier (Photomultiplier, PMT), which is able to register individual photons. If the light from the excitation light source is attenuated to such an extent that a signal is only registered after one to five percent of the light flashes, it can be assumed that it is the registration of individual photons. An electronic circuit is used to carry out time measurements, which are started by an additional detector (photodiode) directly at the light source and stopped by the signal from the fluorescence detector. By discretizing the time signal, a histogram (dependent on the resolution of the analog-to-digital converter used) is obtained after running through many excitation/measurement cycles, the envelope of which corresponds to the signal of an analog recording of the time-resolved intensity curve of the fluorescence after a single high-power excitation pulse.

Another method is measurement in the frequency range (phase fluorometry). Here, the sample is irradiated with intensity-modulated light. The emitted fluorescent light, which is modulated at the same frequency, is detected. However, the modulation amplitude is reduced and a phase shift occurs.

CMOS camera sensors work with different shutter concepts. Cameras with global shutters, for example, are used in most image processing systems. The advantage of a global shutter is that all pixels of the sensor can be exposed simultaneously for a defined time, the exposure time.

In sensors with global reset or global start shutter, the exposure of all pixels starts simultaneously (as with the global shutter) and ends line by line (as with the rolling shutter). The resulting different exposure times are avoided by using a mechanical central shutter or a flash lamp with a defined end of the exposure time.

With a sensor with a rolling shutter, on the other hand, the pixels are exposed one after the other in lines or columns, wherein an image period (1/frame rate) is required until all pixels on the sensor are active or sensitive to light. This effect becomes visible when an object moves. Sensors with rolling shutters enable pixel architectures with fewer transistors, which saves costs and, under certain circumstances, also leads to improved image quality.

In Xiong, Bo, and Qiyin Fang: “Luminescence Lifetime Imaging Using a Cellphone Camera with an Electronic Rolling Shutter.” Optics Letters 45, no. 1 (Jan. 1, 2020): 81. https://doi.org/10.1364/OL.45.000081 a method for measuring fluorescence or luminescence lifetimes using a camera with an electronic rolling shutter is described. According to the known method, the color camera and its rolling shutter effect are used to measure the phase shift of excitation light and fluorescence signal.

In Fratto Brian E. ET AL: “Leveraging a smartphone to perform timegated luminescence measurements”, PLOS ONE, Vol. 18, No. 10, 30. Oct. 2023(2023 Oct. 30), page e0293740, XP093292313, the determination of luminescence decaying curves by means of a rolling shutter image sensor after pulsed luminescence excitation which is performed several times during a rolling shutter period is described.

US 2021/117642 A discloses a similar system as described above.

### SUMMARY OF THE INVENTION

The object of the invention is to simplify the determination of the intensity of a luminescence of markers present in a test field.

To achieve the object of the invention, the invention relates according to a first variant to a method for determining the intensity of the luminescence of markers present in a test field, e.g. of an immunoassay, e.g. of a lateral flow assay, with a known time constant representative of the time course of the luminescence, wherein the test field is reflective for excitation light in at least a partial region, and wherein in the method
the test field is illuminated with pulsed excitation light that has a pulse period and a pulse duration,
the pulsed illuminated test field is recorded by means of a camera comprising a rolling shutter image sensor with a 2D photodiode array, wherein the image sensor is operated using
   an image period which is the reciprocal of the refresh rate,
   a line frequency for the sequential switching of the activation of a line of photodiodes of the 2D photodiode array,
   an integration duration for which a line remains switched active, and an image recording duration within which all lines of photodiodes of the 2D photodiode array have been activated once,
   wherein each photodiode provides a signal representative of the respective intensity of received light,
the pulse period of the excitation light is at most equal to the image recording duration of the image sensor,
as a result of the pulsed illumination by the camera, images of the test field are recorded which have alternately successive parallel light and dark stripes, the bright stripes arising as a result of reflection of the excitation light from the test field and as a result of the luminescence of potential markers and/or as a result of potential autoluminescence of the test field, and the dark stripes arising as a result of the excitation light being absent in an illumination pause between two successive illumination pulses,
said stripes are stationary in the images if the pulse period is an integer fraction of the image period, and shift between successive images if the pulse period is a non-integer fraction of the image period,
wherein, when markers are present in the test field, at least some of the photodiodes of some rows of the 2D photodiode array detect luminescence within the dark stripes, which appears in one or more of the dark stripes of the images as line or band regions which extend with decaying intensity transversely to the extension of the light and dark stripes starting from a bright stripe to the adjacent dark stripe following the bright stripe in time, and
wherein the decaying brightness of the luminescence within a dark stripe and the known time constant defining the time course of the luminescence lifetime are used to infer the intensity of the luminescence at a given reference time.

Accordingly, the invention proposes to measure the luminescence intensity and luminescence lifetime using an image sensor that operates according to the rolling shutter concept. The object or test field is illuminated with a light source whose intensity is modulated over time, namely a pulsed light source. A camera device with a rolling shutter image sensor records the brightness distribution during the duration of the excitation illumination pulses and during the duration of the illumination pauses. An image processing algorithm is used to select areas of the images to be analyzed and the relative intensity of the light source at the time the image line was captured is determined from the distribution of brightness for each image line in the areas to be analyzed. For image lines that were captured at times with minimum intensity, the time interval since this intensity was reached is determined and assigned to the image lines. Optionally, this is done for image lines that were captured at times of maximum intensity, wherein the time elapsed since the pulsed light source was switched on is determined. Partial images are extracted from the images, which consist of image lines each with the same assigned time interval. Reconstructed images are put together from partial images that have the same assigned time intervals, so that each reconstructed image reflects the brightness distribution in the object field averaged over the assigned time interval.

A special feature of the invention is the modulation of the excitation light source by pulsing. It is advantageous if the intensity of the excitation light drops to at least 50% or at least 40% or at least 30% or at least 20% and in particular to almost 0% within a very short time when it is switched off, i.e. at the end of an illumination pulse. The duration within which this drop in the intensity of the excitation light should occur is less than the switching time required by the rolling shutter to switch (activate) a photodiode line or column.

As already described above, the pixels of a sensor with a rolling shutter are exposed one after the other in lines or columns. The duration for which a pixel row or pixel column is activated (i.e. exposed) is called the integration time. With the rolling shutter concept, one or more lines or columns can be successively exposed, i.e. activated. The integration time is then correspondingly shorter or longer. If, for example, the switching time, i.e. the activation time, is 10 μs per line or column, then with a rolling shutter concept in which only one line or column is activated at a time, the integration time would be equal to the activation time of one line. With a rolling shutter concept, in which several lines or columns of pixels are activated overlapping each other in time, the integration time increases accordingly. If, for example, two neighboring lines or columns of pixels are successively activated with overlapping activation times, one column would be activated for 10 μs before the neighboring line or column is activated. While the neighboring line or column is activated, the first mentioned line or column is still activated. The activation time for said lines or column ends at the moment when the third column adjacent to the second column is activated. In this way, two neighboring lines or columns of pixels “travel through” the 2D photodiode array of the sensor. The integration time would then be 20 μs (with 10 μs switching from line to line).

In an advantageous further development of the invention, it is provided that
the camera is used to record as many images until each line of photodiodes of the 2D photodiode array is activated and/or remains activated during at least two illumination pulses, wherein the respective time interval from the end of the respective preceding illumination pulse is different, and
the intensity at a given reference time is inferred from the signals representative of the luminescence intensity supplied by one or more photodiodes of such a line during said at least two illumination pulses and from the time course of the luminescence lifetime represented by the known time constant.

According to this embodiment of the invention, the images captured by the camera comprise images in which each line of photodiodes of the 2D photodiode array is/or remains activated during at least two illumination pauses, although the respective time interval from the end of the respective preceding illumination pulse is different. The decaying luminescence intensity is thus detected at two different times by the photodiodes of said two lines. The known time constant can then be used to determine the intensity of the luminescence at a given reference time.

It is also advantageous if the reference time is the end of the illumination pulse causing a bright stripe or the end of the illumination pause following an illumination pulse.

In another advantageous configuration of the invention, it is provided that
so many images are recorded with the camera that each line of photodiodes of the 2D photodiode array is activated and/or remains activated at least once at that time which defines the beginning of the illumination pause following the end of an illumination pulse, and
this time is the reference time and the signal supplied by a photodiode of a line represents the intensity of the luminescence to be determined.

In this exemplary embodiment of the invention, the end of an illumination pulse is the reference time at which the intensity of the luminescence is to be determined.

Whereas in the first variant of the invention described above the test field has light-reflecting properties, in a second variant of the invention this test field can additionally have short-lived second markers, the luminescence lifetime of which is significantly shorter and in particular at least two orders of magnitude, i.e. at least two powers of 10 shorter than that of the first markers, which also contribute to the formation of the bright image regions, wherein in this method
the luminescence lifetime of the second marker is shorter than 0.01 of the luminescence lifetime of the first marker,
the test field is illuminated with pulsed excitation light that has a pulse period and a pulse duration,
the pulsed illuminated test field is recorded by means of a camera comprising a rolling shutter image sensor with a 2D photodiode array, wherein the image sensor is operated using a image period which is the reciprocal of the refresh rate, a line frequency for the sequential switching of the activation of a line of photodiodes of the 2D photodiode array, an integration duration for which a line remains switched active, and an image recording duration within which all lines of photodiodes of the 2D photodiode array have been activated once, wherein each photodiode provides a signal representative of the respective intensity of received light,
the pulse period of the excitation light is at most equal to the image recording duration of the image sensor, and
as a result of the pulsed illumination by the camera, images of the test field are recorded which have alternately successive parallel light and dark stripes, the bright stripes arising as a result of potential reflection of the excitation light from the test field and as a result of the luminescence of potential first markers and as a result of potential autoluminescence of the test field and as a result of the luminescence of the second markers, and the dark stripes arising as a result of the excitation light being absent in an illumination pause between two successive illumination pulses,
wherein, when first markers are present in the test field, at least some of the photodiodes of some rows of the 2D photodiode array detect luminescence within the dark stripes, which appears in one or more of the dark stripes of the images as line or band regions which extend with decaying intensity transversely to the extension of the light and dark stripes starting from a bright stripe to the adjacent dark stripe following the bright stripe in time,
wherein so many images are recorded with the camera that each line of photodiodes of the 2D photodiode array is activated and/or remains activated at least once at that time which defines the beginning of the illumination pause following the end of an illumination pulse, and
wherein this time is the reference time and the signal supplied by a photodiode of a line represents the intensity of the luminescence to be determined.

Finally, according to the invention, the totality of markers in a test field, e.g. of an immunoassay, e.g. of a lateral flow assay, can also be determined, wherein the markers have a known luminescence lifetime and the intensity of the luminescence is proportional to the amount of markers, wherein in this method
the intensity of the luminescence is determined at a reference time by means of one of the above-mentioned methods, and
a subset of markers is determined based on the magnitude of the signal of each luminescence detecting photodiode and the known proportionality of the amount of markers to the luminescence intensity, and
the total quantity of markers in the test field is determined by adding all subsets of markers determined in this way, and/or
the distribution of the marker within the test field is determined using the subsets of markers.

In this variant of the invention, the known proportionality of luminescence intensity and marker quantity is thus utilized, wherein the determination of the marker quantity and its distribution can be determined according to one of the previously mentioned methods.

Finally, a sample can also be tested for contaminations on the basis of the methods according to the invention, wherein the sample has luminescence markers with known time constants representative of the time course of the luminescence lifetime, and wherein in the method the time course of the luminescence lifetime is formed from the at least two luminescence intensities at two different points in time and the time constant representing this time course is determined on the basis of this time course, which is compared with the known and expected time constant of the luminescence lifetime of the luminescent markers and a deviation of both time constants is an indication of contamination of the sample.

This concept can be further developed in that the time constant of the luminescence lifetime is known for at least one contaminant in the sample and that by comparing the determined time constant with said at least one time constant it is recognized whether the sample is contaminated with the contaminant or with which of several potential contaminants the sample is contaminated.

Finally, the intensity of the luminescence of luminescence markers present in a sample with a known time constant representative of the time course of the luminescence lifetime can also be determined as a function of wavelength, wherein in this method the sample is examined in accordance with one of the preceding methods and a spectral analysis of the luminescence is carried out by using a polychromator to record the luminescence received from an activated line of the 2D photodiode array as a function of wavelength from the photodiodes of the relevant line and thus using the signals representative of the course of the luminescence lifetime supplied by a photodiode of such a line to draw wavelength-selective conclusions about the intensity at a respectively given, common reference time.

In the following, the concept according to the invention is explained using a column-wise exposure/activation of the pixels of a 2D photodiode array.

As described above, the excitation light source is operated in pulsed mode, i.e. clocked.

The time-resolved intensity curve of the fluorescence (or more generally the luminescence) is determined by running through many excitation/measurement cycles.

Here, two cases must be distinguished:

In the first case, the clocking of the sample is not synchronized on the hardware side with the clocked operation of the sensor. The illumination by the excitation light has its own clock, which is stabilized and is a non-integer multiple of the image frequency of the image sensor. The pulse duration of the excitation light is less than the difference between the integration time of the image sensor and the pulse period of the illumination. This creates a kind of beat. Beating refers to the effect that the resultant of the additive superposition of two oscillations, which differ only slightly in frequency, has a periodically increasing and decreasing amplitude.

As the pixels are exposed line by line, image processing can be used to recognize in which lines the illumination pulse had the maximum energy (“excitation line”). Since the lines are exposed one after the other, the time difference between the exposures of the lines is precisely known. After running through a few excitation and measurement cycles, a recording of the time-resolved intensity curve of the fluorescence for one line is obtained. If the “excitation line” then slowly shifts across the sensor due to the above-mentioned differences in the frequency of the excitation illumination pulses and the repetition frequency of the image sensor, an image of the time-resolved fluorescence (generally luminescence lifetime) is obtained of the entire test field to be examined.

The decaying brightness of the fluorescence within the dark stripes of the image, which show recordings of parts of the test area when the excitation light is switched off, and the known time constant defining the time course of the luminescence or fluorescence lifetime can then be used to draw conclusions about the intensity of the fluorescence or luminescence at a given reference time.

In addition to the dark stripes described/mentioned above, the recorded image also shows bright stripes. These bright stripes are not meaningful for the examinations to be carried out to determine the intensity of the luminescence. The decisive factor is rather the “afterglow stripes” that appear, which begin with the transition from a bright stripe to a dark stripe and typically lose intensity within the dark stripe to such an extent that they merge into the dark of these dark stripes.

It is now crucial that each pixel line or column captures the line area of the test field assigned thereto at the time the excitation light pulse is switched off.

In the second case, the pulse frequency of the light source is an integer multiple of the refresh rate of the image sensor. The pulse duration of the excitation light is less than the difference between the integration time of the image sensor and the pulse period of the illumination. This means that the start of image acquisition, i.e. the activation of the first line, is at the same time within a pulse period for each image. This creates a stationary pattern of bright and dark stripes across all images.

In order to capture the entire test field in the state of the dark stripes, as in the first case, the camera is shifted by the width of a dark stripe perpendicular to the direction of the stripes.

Image processing is now carried out in the same way as in the first case.

### BRIEF DESCRIPTION OF THE DRAWINGS

The invention is described in more detail below by means of an exemplary embodiment and with reference to the drawing.

In detail, the Figures show:

FIG. 1 schematically shows the structure of an arrangement including a pulsed excitation light source and a 2D camera with a rolling shutter image sensor for capturing images of the test field of a lateral flow assay,

FIG. 2 shows an example for the case that one and the same photodiode line or column, according to FIG. 2 it is the column or line 9, detects the decaying luminescence at two different times after the end of the previous illumination pulse, namely in the upper diagram of FIG. 2 after four time units and in the lower diagram of FIG. 2 after one time unit, wherein the intensity of the luminescence at the end of the illumination pulse can be determined on the basis of the two measured intensity values and the known time constant of the luminescence lifetime, i.e. in the upper diagram of FIG. 2 at the time of time unit 6 and in the lower diagram at the time of time unit 8,

FIG. 3 shows an example of the rolling shutter concept for the case that respectively two neighboring photodiode lines or columns travel through the recording,

FIG. 4 shows an attempt to visualize the luminescence afterglow, wherein the stripes provided with lines are intended to represent bright stripes of the recorded image and the white areas are intended to represent dark stripes in which the test bar of the lateral flow assay is visible, since it has afterglowing luminescent markers which are located in the sample to be examined and the intensity of which given at a reference point in time is to be determined, and

FIG. 5 shows a graphic representation of the composition of an overall image of the luminescence of the test bars from individual lines of the “light tails” in the dark stripes of the frames.

### DESCRIPTION OF THE INVENTION

The concept according to the invention will be described below by examining the luminescence lifetime of corresponding markers of a sample of a lateral flow assay. The structure of the rolling shutter principle of a lateral flow assay will not be explained further here. Reference is made in this context to WO-A-2021/209576 as an example.

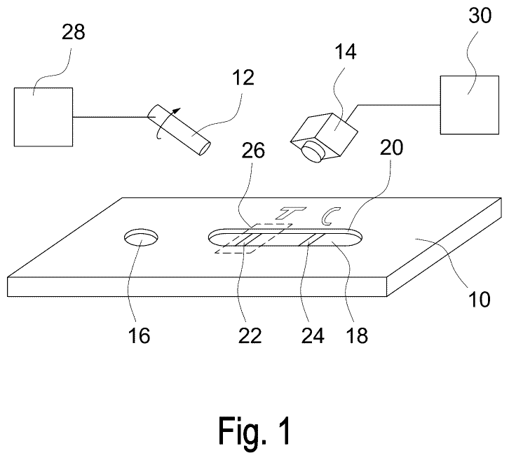

FIG. 1 schematically shows a test setup with the lateral flow assay 10, a pulsed excitation light source 12 and a 2D camera 14 with rolling shutter, as can be found in a large number of smartphones, for example. The lateral flow assay 10 has a sample receiving well 16 in which a received sample “migrates” due to capillary forces along a test strip 18 into an exposed area 20 in which the test strip 18 has a test bar 22 and a control bar 24. The area recorded by the camera 14 is designated with 26. The pulsed excitation light source 12 is controlled by a control unit 28, while the camera 14 is controlled by a control and image evaluation unit 30 and its images are evaluated, respecitvely.

After completion of the lateral flow assay 10, the test field, i.e. the area 26, is exposed in a pulsed manner and filmed. The clock of the pulsed excitation light source 12 is slightly different to the frequency of the camera's image sensor. This results in a “beat”, which in this case means that one and the same pixel line or column of the image sensor of the camera 14 gradually captures the area assigned to this line or column in different phases of the illumination and the illumination pauses.

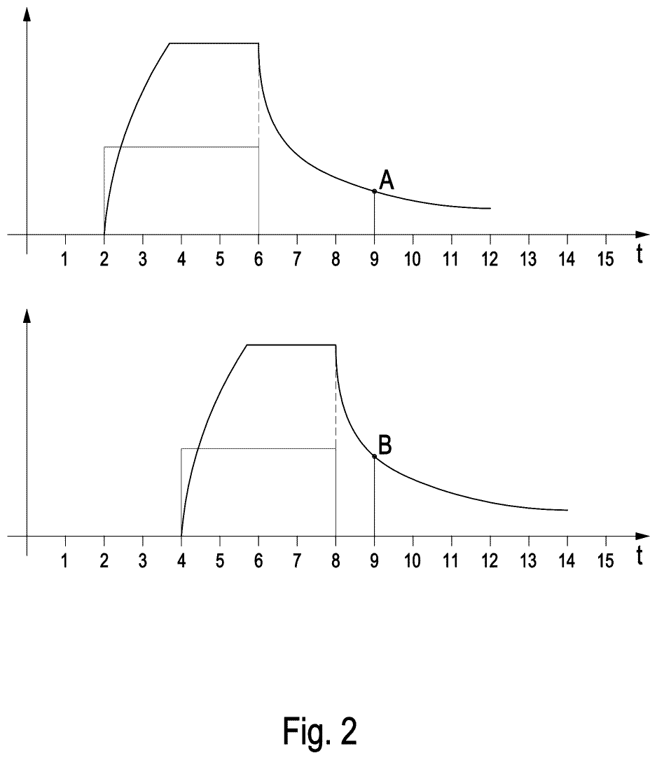

This creates a situation as shown in FIG. 2, for example. It can be seen that test field 26 is illuminated over a period of four time units. At the end of an illumination pulse, the luminescence decreases exponentially. Since the time constant of the luminescence markers in the test field 26 is known, the intensity at a reference time can now be deduced from two intensity values determined at different times after the end of a light pulse. In the example in FIG. 2, one and the same photodiode line or column detects the intensity of the luminescence at time 9 after the end of an illumination pulse. What is special now is that the time is at different distances from the end of the illumination pulse. The measured values A and B can then be used with the known time constant to infer, for example, the value of the luminescence at the time the illumination pulse is switched off.

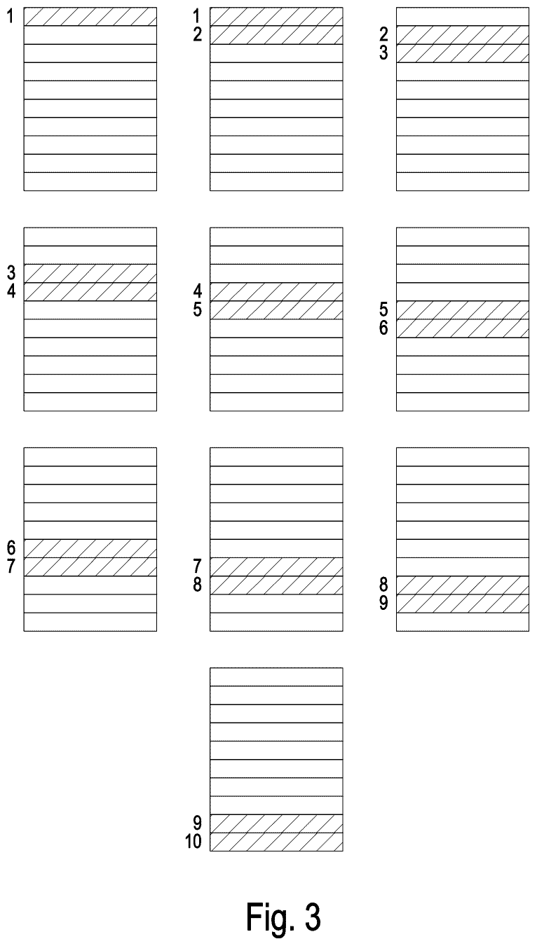

FIG. 3 graphically shows the rolling shutter principle for a two-dimensional sensor with ten photodiode lines of a certain number of photodiodes. The integration time in the exemplary embodiment of FIG. 3 is twice the activation time of a pixel line. In this case, two respectively overlapping activated photodiode lines therefore travel through the image to be recorded.

According to the concept and measurement setup described above, the test field 26 with the test bar 22 is now filmed over a longer period of time until each pixel line or column has captured its assigned area (line or column) of the test field 26 and the test bar 22 at least twice, namely at different times after the end of the respectively last previous illumination pulse.

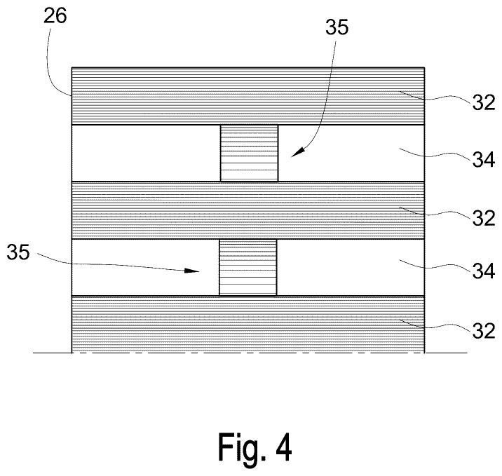

FIG. 4 shows one of the recorded frames which alternately have light stripes 32 and dark stripes 34. Within the dark stripes 34, “light tails” 35 are formed, so to speak, which result from the luminescence lifetime. The intensity in the bright stripes 32 is represented by the density of individual horizontal lines. The increasingly decreasing intensity of the luminescence is symbolized in FIG. 4 by an increase in the distance, i.e. by a reduced density of the lines. These areas, in which luminescence can be detected, correspond to the test bar 22 within the test field 26.

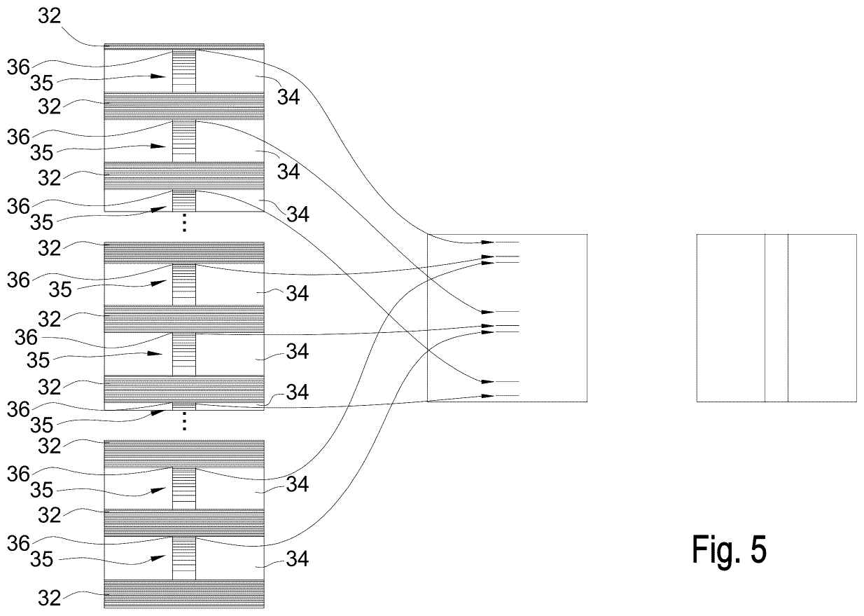

FIG. 5 now shows how a composite overall image (see in the center of FIG. 5) is generated from the frames (shown on the left), which only contains the information from one or a few lines of the dark stripes 34 following the light stripes 32. The “light tails” 35 within the dark stripes 34 are thus combined to form a continuous image, which represents a complete image of the luminescence of the test bar 22 (see right in FIG. 5).

Due to the “beating” already mentioned above, the bright stripes 32 in the frames, of which only three are shown in FIG. 5 as representative of all the frames, are not the same width at the same locations and in particular at the upper edge (but also at the lower edge, not shown). The decisive factor is that each line of the sensor detects the luminescence within a “light tail” 35 at least once, namely in relation to the respective previous bright stripe 32 at the same location within a light tail 35, for example at the first location, i.e. as the first line after a bright stripe 32. In the exemplary embodiment of FIG. 5, the luminescence across the entire test bar 22 is now composed of one photodiode line of each “light tail” 35, with said photodiode line in each “light tail” 35 being at the same position relative to the previous bright stripe 32. This is illustrated in FIG. 5 by the lines and arrows between the three illustrations shown on the left and the illustration in the center. This results in a representation of the luminescence across the entire test bar 22, as shown in FIG. 5 on the right.

The method according to the invention was tested using a lateral flow assay with detector conjugate of europium Eu3+ doped nanoparticles. The test strip was filmed with a smart phone camera under pulsed lighting. A recording of the afterglow of the markers was compiled from the film using the method described here. Image processing was used to quantitatively record the test and control bands of the test strip and calculate the test result.

A 365 nm LED as a pulsed exposure source was modulated by a square-wave signal of 301 Hz and 1 ms pulse duration. The rise and fall times of the generated light pulses were <1 μs. The light from the LED fell on the completely processed test strip and excited both the Europium markings and the carrier material of the strip to fluorescence. The fluorescence lifetime of the europium chelates is approx. 600 μs, that of the carrier material a few ns.

A rolling shutter camera continuously recorded images of the test strip at a frame rate of 60 fps and an exposure time of 500 μs. The line rate of the camera was about 15 μs. The alignment of the camera is lines parallel to the length of the LFT. The strip was captured with optimum image filling. Approx. 100 images were recorded.

The camera captured the images line by line from top to bottom. This means that only active lines integrate the light incident on them. The top line was activated first, followed by the lines below at a frequency of 1/15 μs. Each line remained active for the selected exposure time (500 μs). A window of active lines, approx. 35 lines high, therefore moved across the image field. The time required to capture the image was the image height divided by the line frequency plus the exposure time.

If the lighting were active during the entire exposure time, only a bright surface would be created. The pulsed light source, on the other hand, produces a striped pattern. An illuminated stripe is always created when the window of active lines is “hit” by an illumination pulse.

Since the pulse rate of the illumination source is not an integer multiple of the frame rate of the camera, the stripes between two images shift in relation to each other. After a few hundred images, each line of the image is thus captured at least once in each relative state of line and light source.

### LIST OF REFERENCE NUMERALS

10 lateral flow assay
12 excitation light source
14 2D camera
16 sample receiving well
18 test strip
20 exposed area
22 test bar
24 control bar
26 area of the lateral flow assay captured by the camera
28 control unit
30 control and image evaluation unit
32 bright stripes
34 dark stripes
35 tail of light
36 first line of a dark stripe following a bright stripe
A measured value
B measured value

1. A method for determining the intensity of the luminescence of markers present in a test field, with a known time constant representative of the time course of the luminescence, wherein the test field is reflective for excitation light in at least a partial region, and wherein the method comprises
illuminating the test field with pulsed excitation light that has a pulse period and a pulse duration,
recording the pulsed illuminated test field by means of a camera comprising a rolling shutter image sensor with a 2D photodiode array, wherein the image sensor is operated using
an image period which is the reciprocal of the refresh rate,
a line frequency for the sequential switching of the activation of a line of photodiodes of the 2D photodiode array,
an integration duration for which a line remains switched active, and an image recording duration within which all lines of photodiodes of the 2D photodiode array have been activated once,
wherein each photodiode provides a signal representative of the respective intensity of received light,
wherein the pulse period of the excitation light is at most equal to the image recording duration of the image sensor,
wherein as a result of the pulsed illumination by the camera, images of the test field are recorded which have alternately successive parallel light and dark stripes, the bright stripes arising as a result of reflection of the excitation light from the test field and as a result of the luminescence of potential markers and/or as a result of potential autoluminescence of the test field, and the dark stripes arising as a result of the excitation light being absent in an illumination pause between two successive illumination pulses, and
said stripes are stationary in the images if the pulse period is an integer fraction of the image period, and shift between successive images if the pulse period is a non-integer fraction of the image period,
wherein, when markers are present in the test field, at least some of the photodiodes of some rows of the 2D photodiode array detect luminescence within the dark stripes, which appears in one or more of the dark stripes of the images as line or band regions which extend with decaying intensity transversely to the extension of the light and dark stripes starting from a bright stripe to the adjacent dark stripe following the bright stripe in time, and
wherein the decaying brightness of the luminescence within a dark stripe and the known time constant defining the time course of the luminescence lifetime are used to infer the intensity of the luminescence at a given reference time.

2. The method according to claim 1, wherein
the pulse period is a non-integer fraction of the image period,
the camera is used to record as many images until each line of photodiodes of the 2D photodiode array is activated and/or remains activated during at least two illumination pulses, wherein the respective time interval from the end of the respective preceding illumination pulse is different, and
the intensity at a predetermined reference time is inferred from the signals representative of the luminescence intensity supplied by one or more photodiodes of such a line during said at least two illumination pulses and from the time course of the luminescence lifetime represented by the known time constant.

3. The method according to claim 1, wherein
the pulse period of the light source is an integer fraction of the image period,
stationary light and dark stripes are recorded in the images,
the test field is shifted perpendicular to the stationary strips in relation to the camera and
so many images are taken during this shift that each area of the test field is captured at least once in a dark stripe.

4. The method according to claim 1, wherein the reference time is the end of the illumination pulse causing a bright stripe or the end of the illumination pause following an illumination pulse.

5. The method according to claim 1, wherein
so many images are recorded with the camera that each line of photodiodes of the 2D photodiode array is activated and/or remains activated at least once at that time which defines the beginning of the illumination pause following the end of an illumination pulse, and
this time is the reference time and the signal supplied by a photodiode of a line represents the intensity of the luminescence to be determined.

6. The method according to claim 1, wherein the test field is an immunoassay or a lateral flow assay.
